(19) United States
(12) Patent Application Publication
(10) Pub. No.: US 2013/0025624 A1
(43) Pub. Date: Jan. 31, 2013

(54) METHOD OF CLEANING A SEMICONDUCTOR DEVICE MANUFACTURING APPARATUS

(71) Applicants: Jeon-Ho Kim, Hwaseong-si (KR); Chul-Hwan Choi, Seoul (KR); Seung-Tae Lee, Hwaseong-si (KR); Yong-Gyu Lim, Suwon-si (KR); Kyung-Tae Kim, Suwon-si (KR); Jae-Min Kim, Hwaseong-si (KR)

(72) Inventors: Jeon-Ho Kim, Hwaseong-si (KR); Chul-Hwan Choi, Seoul (KR); Seung-Tae Lee, Hwaseong-si (KR); Yong-Gyu Lim, Suwon-si (KR); Kyung-Tae Kim, Suwon-si (KR); Jae-Min Kim, Hwaseong-si (KR)

(73) Assignee: Samsung Electronics Co., Ltd.

(21) Appl. No.: 13/546,645

(22) Filed: Jul. 11, 2012

(30) Foreign Application Priority Data
Jul. 26, 2011 (KR) 10-2011-0073951

(51) Int. Cl. B08B 7/00

(52) U.S. Cl. 134/1.2

(57) ABSTRACT

According to example embodiments, there is provided a method of cleaning a semiconductor device manufacturing apparatus. In the method, a fluorine-containing gas is provided into a chamber to clean a byproduct formed on a surface of a chamber during formation of a layer structure therein. A material is provided into the chamber to chemisorb the material on the surface of the chamber. The material is substantially similar to or the same as a source gas for forming the layer structure. A plasma is generated in the chamber, and the chamber is purged.

### CROSS-REFERENCE TO RELATED APPLICATION

This application claims priority under 35 USC §119 to Korean Patent Application No. 10-2011-0073951, filed on Jul. 26, 2011 in the Korean Intellectual Property Office (KIPO), the contents of which are herein incorporated by reference in its entirety.

### FIELD OF THE INVENTIVE CONCEPT

Example embodiments relate to methods of cleaning semiconductor device manufacturing apparatuses. More particularly, example embodiments relate to methods of cleaning semiconductor device manufacturing apparatuses by removing remaining fluorine therein.

### BACKGROUND

When a layer structure is formed on a substrate in a deposition chamber by an atomic layer deposition (ALD) process or a chemical vapor deposition (CVD) process, a byproduct of a source gas for forming the layer structure may be deposited on an inner surface of the deposition chamber to form a thin film. At least a portion of the thin film may be separated from the inner surface of the deposition chamber, and may be dropped on the substrate to generate a defect in the layer structure. Therefore, a process for cleaning the deposition chamber by removing the thin film may be employed. When a silicon oxide (SiOx) thin film is formed on the inner surface of the deposition chamber, a method of cleaning the deposition chamber by using a gas containing fluorine has been developed. However, the gas containing fluorine may remain in the deposition chamber after the cleaning process and generate a defect in the layer structure.

### SUMMARY

Example embodiments provide a method of cleaning a semiconductor device manufacturing apparatus effectively by removing remaining fluorine therein.

According to example embodiments, there is provided a method of cleaning a semiconductor device manufacturing apparatus. In the method, a fluorine-containing gas is provided into a chamber to clean a byproduct formed on an inner surface of the chamber during formation of a layer structure therein. A material is provided into the chamber to chemisorb the material on the inner surface of the chamber. The material is substantially similar to or the same as a source gas used to form the layer structure. A plasma is generated in the chamber. The chamber is purged to remove substantially the fluorine-containing gas.

In an example embodiment, the layer structure and the byproduct may include silicon oxide.

In an example embodiment, the source gas may include at least one of di-isopropylaminosilane (DIPAS), tetra ethyl ortho silicate (TEOS), trimethyl phosphate (TMOP), and triethyl borate (TEB).

In an example embodiment, generating the plasma may include forming silicon fluoride (SiFx) and hydrogen fluoride (HF).

In an example embodiment, generating the plasma may include performing a direct plasma process.

In an example embodiment, providing the material and generating the plasma may be performed at a temperature substantially the same as a temperature employed during a process for forming the layer structure.

In an example embodiment, providing the fluorine-containing gas, providing the material, generating the plasma and purging the chamber are performed at a temperature substantially the same as the temperature of the process for forming the layer structure.

In an example embodiment, prior to generating the plasma, a carrier gas may be further provided into the chamber to purge the chamber.

In an example embodiment, after providing the fluorine-containing gas, a carrier gas may be further provided into the chamber to exhaust from the chamber a remaining gas that contains fluorine.

In an example embodiment, providing the material, generating the plasma and purging the chamber may be performed repeatedly.

In an example embodiment, the layer structure may be formed by an atomic layer deposition (ALD) process or a chemical vapor deposition (CVD) process.

In an example embodiment, after providing the material, a hydrogen-containing gas may be further provided into the chamber, the plasma may be further generated in the chamber, and the chamber may be further purged.

In an example embodiment, prior to providing the material, a hydrogen-containing gas may be further provided into the chamber, the plasma may be generated in the chamber, and the chamber may be purged.

In an example embodiment, after purging the chamber, a hydrogen-containing gas may be further provided into the chamber, the plasma may be generated in the chamber, and the chamber may be purged.

According to example embodiments, a silicon oxide deposited on an inner surface of a chamber may be firstly removed using a gas containing fluorine, a material substantially similar to or the same as a source gas used during the deposition process of the silicon oxide may be chemisorbed on the inner surface of the chamber, and then a plasma may be generated. The plasma may facilitate a reaction between the material chemisorbed on the inner surface of the chamber and the fluorine compounds. A temperature in the chamber during the remaining fluorine removal process may be substantially the same as a temperature during the deposition process. Therefore, a time for changing the temperature in the chamber may not be necessary, and thus, the process time may be reduced.

### BRIEF DESCRIPTION OF THE DRAWINGS

FIG. 1 is a cross-sectional view illustrating a semiconductor device manufacturing apparatus in accordance with example embodiments;

FIG. 2 is a flow chart illustrating a method of cleaning a semiconductor device manufacturing apparatus in accordance with example embodiments;

FIG. 3 is a timing diagram illustrating a method of cleaning a semiconductor device manufacturing apparatus in accordance with example embodiments;

FIG. 4 is a graph illustrating an amount of silicon tetrafluoride in a chamber with respect to time;

FIG. 5 is a graph illustrating an amount of a fluorine atom in a silicon oxide layer deposited on the silicon substrate, while performing a method of cleaning a semiconductor device manufacturing apparatus in accordance with a comparative example;

FIG. 6 is a graph illustrating an amount of a fluorine atom in a silicon oxide layer deposited on the silicon substrate, while performing a method of cleaning a semiconductor device manufacturing apparatus in accordance with example 2;

FIG. 7 is a flow chart illustrating a method of cleaning a semiconductor device manufacturing apparatus in accordance with other example embodiments; and

FIG. 8 is a timing diagram illustrating a method of cleaning a semiconductor device manufacturing apparatus in accordance with other example embodiments.

### DETAILED DESCRIPTION

Various example embodiments will be described more fully hereinafter with reference to the accompanying drawings, in which some example embodiments are shown. The present inventive concept may, however, be embodied in many different forms and should not be construed as limited to the example embodiments set forth herein. Rather, these example embodiments are provided so that this description will be thorough and complete, and will fully convey the scope of the present inventive concept to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present inventive concept.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be explained in detail with reference to the accompanying drawings.

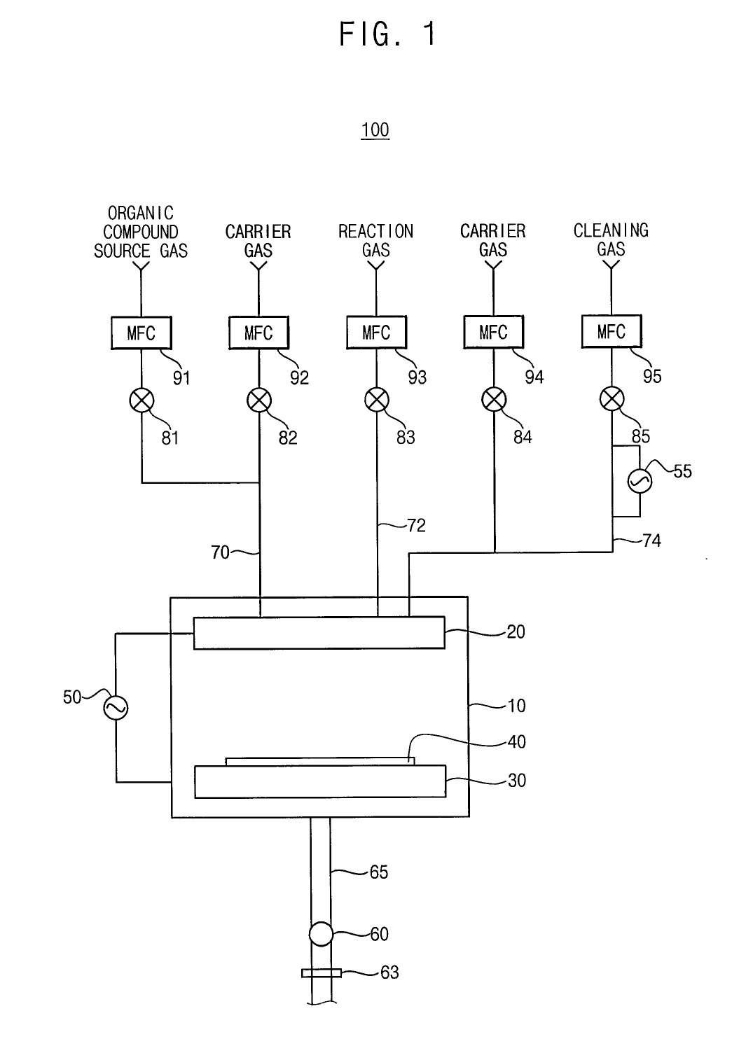

FIG. 1 is a cross-sectional view illustrating a semiconductor device manufacturing apparatus in accordance with example embodiments.

Referring to FIG. 1, a semiconductor device manufacturing apparatus 100 may include a chamber 10, a plurality of gas supply lines 70, 72, and 74, a high frequency power supply 50, a remote power supply 55, an exhaust line 60, and a pump 63.

The chamber 10 may provide a space for a deposition process of a semiconductor device, and a deposition process such as an atomic layer deposition (ALD) process or a chemical vapor deposition (CVD) process may be performed therein. In example embodiments, the chamber 10 may include a chuck 30 and a shower head 20. The chuck 30 may support a substrate 40, e.g., a silicon wafer and various gases may enter the chamber 10 through the shower head 20. The shower head 20 may also serve as an electrode during generation of plasma. In example embodiments, a gas flow type chamber may be used instead of a shower head type chamber 10.

The plurality of gas supply lines 70, 72 and 74 may include a source gas supply line 70, a reaction gas supply line 72 and a cleaning gas supply line 74. The source gas supply line 70 may be connected to the shower head 20 of the chamber 10 to provide a source gas which may supply a source material for forming a layer structure. The reaction gas supply line 72 may provide a reaction gas which may be reacted with the source gas in the chamber 10 to form the layer structure. The cleaning gas supply line 74 may provide a cleaning gas which may remove byproducts deposited in the chamber 10.

The source gas and a carrier gas for transferring the source gas may be provided to the chamber 10 through the source gas supply line 70. In an example embodiment, the source gas supply line 70 may include two lines through which the source gas and the carrier gas may be transferred, respectively. For example, the source gas may include di-isopropylaminosilane (DIPAS), tetra ethyl ortho silicate (TEOS), trimethyl phosphate (TMOP), triethyl borate (TEB), etc., and the carrier gas may include argon (Ar), nitrogen (N₂), helium (He), etc.

The reaction gas may include, for example, oxygen (O₂), ozone (O₃), water (H₂O), peroxide (H₂O₂), etc.

The cleaning gas and a carrier gas for transferring the cleaning gas may be provided into the chamber 10 through the cleaning gas supply line 74. In an example embodiment, the cleaning gas supply line 74 may include two lines for providing the cleaning gas and the carrier gas, respectively. For example, the cleaning gas may include molecules containing fluorine, e.g., hexafluoroethane (C₂F₆) and nitrogen trifluoride (NF₃).

Valves 81, 82, 83, 84 and 85 for switching flows of the gases and mass flow controllers 91, 92, 93, 94 and 95 for controlling flow rates of the gases may be disposed at the source gas supply line 70, the reaction gas supply line 72 and the cleaning gas supply line 74.

The high frequency power supply 50 may be connected to the shower head 20 and the chuck 30, and may supply power for generating plasma directly in the chamber 10. On the other hand, the remote power supply 55 may be connected to the cleaning gas line 74, and may supply power for generating remote plasma outside the chamber 10.

The pump 60 may be mounted on an exhaust line 65 connected to the chamber 10, and may exhaust unreacted gases and remaining gases in the chamber 10. A scrubber 63 for filtering exhausted gases may be further mounted on the exhaust line 65.

The exhaust line 65 may include a stainless steel coated with fluorine resin, and thus, the exhaust line 65 may not be significantly corroded by the cleaning gas entering the chamber 10.

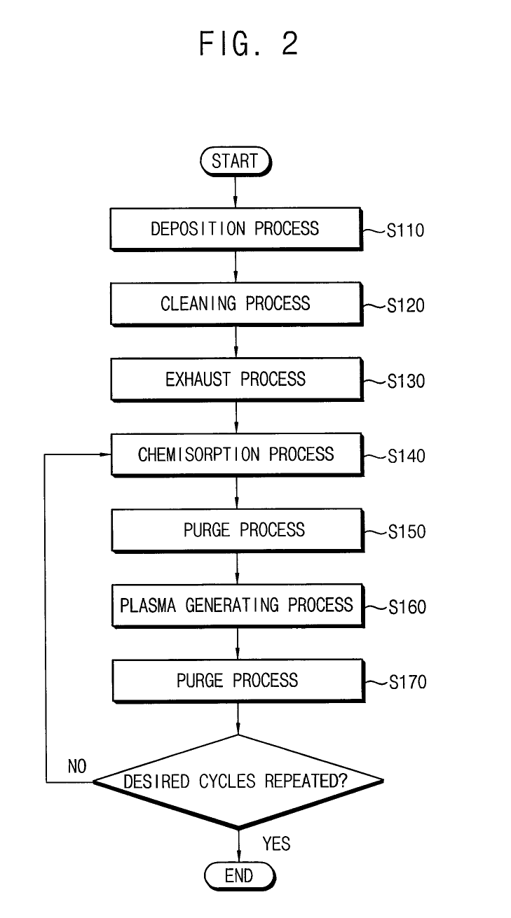

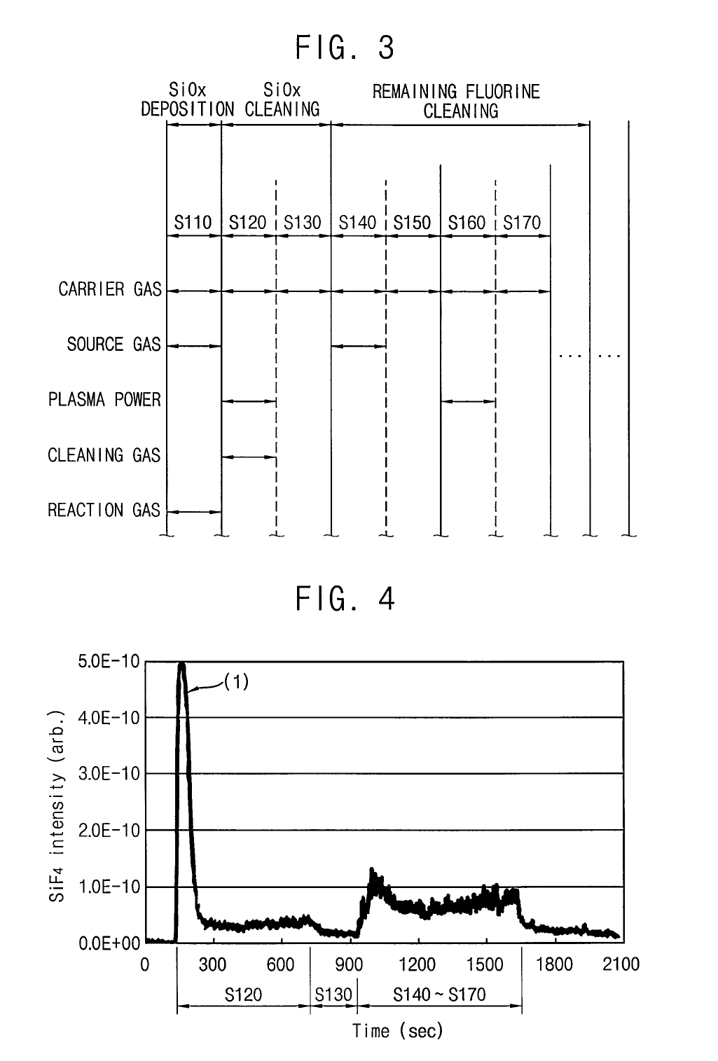

FIG. 2 is a flow chart illustrating a method of cleaning a semiconductor device manufacturing apparatus in accordance with example embodiments, and FIG. 3 is a timing diagram illustrating a method of cleaning a semiconductor device manufacturing apparatus in accordance with example embodiments.

The semiconductor device manufacturing apparatus in which the cleaning process is performed may be a semiconductor device manufacturing apparatus described with reference to FIG. 1. That is, the semiconductor device manufacturing apparatus may include the chamber 10 for performing an ALD process or a CVD process. For the convenience of explanation, only a method of cleaning the chamber 10 wherein a CVD process is performed is illustrated, however, a method wherein an ALD process is performed would be readily appreciated by one skilled in the art in view at least in view of the description provided herein.

Referring to FIGS. 1, 2 and 3, a layer structure may be formed on the substrate 40 in the chamber 10 in a step S110, i.e., in a deposition process. The layer structure may be formed on the substrate 40 by providing a source gas and a carrier gas into the chamber 10 through the source gas supply line 70 and by providing a reaction gas into the chamber 10 through the reaction gas supply line 72. In example embodiments, the source gas may include di-isopropylaminosilane (DIPAS), tetra ethyl ortho silicate (TEOS), trimethyl phosphate(TMOP), triethyl borate (TEB), etc., the carrier gas may include Ar, N₂, He, etc., and the reaction gas may include O₂, H₂O, H₂O₂, etc. Therefore, the layer structure including a silicon oxide layer (not shown) may be deposited on the substrate 40, and a byproduct (not shown) including silicon oxide (SiOx) may be formed on an inner surface of the chamber 10. As described above, the layer structure may be formed by an ALD process as well as the CVD process.

In a step S120, i.e., in a cleaning process, a cleaning gas and the carrier gas may be provided into the chamber 10 through the cleaning gas supply line 74, so that the cleaning gas may remove the byproduct, which may include the silicon oxide (SiOx), on the inner surface of the chamber 10.

In example embodiments, the cleaning gas may include C₂F₆ and/or NF₃, and the carrier gas may include Ar, N, He, etc. A pressure and a gas ratio in the chamber 10 may be adjusted by providing the carrier gas.

In example embodiments, the pressure in the chamber 10 may be maintained at a pressure in a range of about 2 Torr to about 5 Torr, and a temperature in the chamber 10 may be maintained at a temperature below about 500° C. In an example embodiment, a temperature in the chamber 10 during the cleaning process may be substantially the same as a temperature during the deposition process. Accordingly, the temperature in the chamber 10 may not change, so that a process time for performing the cleaning process may be reduced.

In step S120, a plasma may be formed in the chamber 10. In example embodiments, the plasma may be generated by a remote plasma process. That is, the cleaning gas may be excited outside the chamber 10. More particularly, the remote power supply 55 may be connected to the cleaning gas supply line 74 to form the plasma, and then the generated plasma may enter the chamber 10. When using the plasma generated by the remote power supply 55, a cleaning efficiency may be reduced, however, damage of the chamber 10 may be prevented or reduced. In an example embodiment, the remote power supply 55 may provide a power in a range of about 5000 W to about 15000 W at a frequency of about 400 KHz.

Fluorine radical (F*) in the plasma and silicon oxide in the byproduct may be reacted to form a silicon tetrafluoride (SiF₄) gas and an oxygen (O₂) gas which may be volatile. The cleaning process may be performed for about 3 minutes to about 10 minutes.

In a step S130, i.e., in an exhaust process, the carrier gas may be provided into the chamber 10 through the cleaning gas supply line 74, and the volatile SiF₄ gas and O₂ gas may be exhausted outside the chamber 10 through the exhaust line 65.

The exhaust process may be performed for at least 1 minute. Even though a process time of the exhaust process may be extended, remaining fluorine atoms or remaining fluorine radicals may not be entirely removed in the chamber 10.

In a step S140, i.e., in a chemisorption process, an organic compound source gas and the carrier gas may be provided into the chamber 10 through the source gas supply line 70, so that an organic compound source material may be chemisorbed on the inner surface of the chamber 10.

The organic compound source gas may be substantially similar to or the same as the source gas used in the deposition process. In example embodiments, the organic compound source gas may include di-isopropylaminosilane (DIPAS), tetra ethyl ortho silicate (TEOS), trimethyl phosphate (TMOP), triethyl borate (TEB), etc., and the carrier gas may include Ar, N₂, He, etc.

In an example embodiment, the chemisorption process may be performed for a time period in a range of about 0.5 seconds to about 2 seconds, however, the process time of the chemisorption process may vary in accordance with the size of the chamber 10 and/or the lengths and layouts of the gas supply lines 70, 72 and 74 as understood by one of skill in the art.

In a step S150, i.e., in a first purge process, the carrier gas may be provided into the chamber 10 through the source gas supply line 70, so that the remaining organic compound source gas in the chamber 10 may be exhausted to purge the chamber 10. Alternatively, the carrier gas may be provided through the cleaning gas supply line 74.

Therefore, the organic compound source gas that may not be chemisorbed on the inner surface of the chamber 10 may be exhausted out of the chamber 10 through the exhaust line 65. The first purge process may be performed for a period of time in a range of about 0.5 seconds to about 2 seconds, however, the process time of the first purge process may vary in accordance with the size of the chamber 10 and the capacity of the pump 60 as understood by one skilled in the art.

In step S160, i.e., in a plasma generating process, a plasma may be generated in the chamber 10 as the carrier gas may be provided into the chamber 10.

In example embodiments, a power from the high frequency power supply 50 may be applied into the chamber 10 to generate a plasma directly in the chamber 10. In an example embodiment, the high frequency power supply 50 may apply a power in a range of about 200 W to about 400 W.

The direct plasma may include a radical having a relatively high energy to facilitate a reaction between the source material chemisorbed on the inner surface of the chamber 10 and the remaining fluorine atoms and/or the remaining fluorine radicals, so that silicon fluoride (SiFx) and hydrogen fluoride (HF), which may be volatile, may be formed in the chamber 10.

The plasma generating process may be performed for a period of time in a range of about 0.5 seconds to about 3 seconds, however, the process time of the plasma generating process may vary in accordance with the size of the chamber 10 and the capacity of the high frequency power supply 50 as understood by one skilled in the art.

In step S170, in a second purge process, the carrier gas may be provided into the chamber 10, so that the remaining SiFx and HF gases formed during the plasma generating process may be exhausted to purge the chamber 10.

Therefore, the SiFx gas and/or the HF gas may be exhausted out of the chamber 10 through the exhaust line 65. The second purge process may be performed for a period of time in a range of about 0.5 seconds to about 3 seconds, however, the process time of the second purge process may vary in accordance with the size of the chamber 10 and the capacity of the pump 60 as understood by one skilled in the art.

The remaining fluorine removal process, which may include the above-described processes (step S140 to step S170), that is, the chemisorption process (step S140), the first purge process (step S150), the plasma generating process (step S160) and the second purge process (step S170) may be repeated, so that the remaining gas containing fluorine in the chamber 10 may be removed sufficiently. In example embodiments, the processes for removing the remaining fluorine may be repeated from a range of times from about 50 times to about 100 times.

In example embodiments, the remaining fluorine removal process may be performed under a pressure in a range of about 1 Torr to about 3 Torr at a temperature in a range of about a room temperature to about 500° C. In an example embodiment, a temperature in the chamber 10 in the remaining fluorine removal process may be substantially the same as a temperature in the processes described in step S110 to step S130. Therefore, time for changing the temperature in the chamber 10 may not be necessary, so that the process time of the remaining fluorine removal process may be reduced.

As mentioned above, in the method of cleaning the semiconductor device manufacturing apparatus, the remaining fluorine in the chamber 10 may be removed using a material substantially similar to or the same as the material used in the deposition process of the silicon oxide layer. Further, the cleaning process and the remaining fluorine removal process may be performed in-situ at a temperature substantially the same as the temperature of the deposition process, so that the method may clean the semiconductor device manufacturing apparatus efficiently.

### Evaluation of the Effect of Removing the Remaining Fluorine in the Chamber

### Example 1

An amount of SiF₄ gas in the chamber 10 was observed by a residual gas analyzer spectrum, and the effect of removing the remaining fluorine in the chamber 10 was evaluated. Particularly, the deposition process (step S110), the cleaning process (step S120), and the exhaust process (step S130) were performed in the chamber 10, and then the processes for removing the fluorine including the chemisorption process (step S140), the first purge process (step S150), the plasma generating process (step S160), and the second purge process (step S170) was performed repeatedly. The amount of the SiF₄ gas in the chamber 10 was illustrated in FIG. 4.

FIG. 4 is a graph illustrating the amount of SiF₄ in the chamber 10.

Referring to FIG. 4, the amount of the remaining SiF₄ gas (1) was increased in a period of about 900 seconds to about 1600 seconds when compared with a period before and after the remaining fluorine removal process. In the remaining fluorine removal process, the fluorine atoms or radicals adsorbed on the inner surface of the chamber 10 were reacted with the organic compound source gas to form the SiF₄ gas, so that the amount of the SiF₄ gas in the chamber 10 increased. Then, the SiF₄ gas was exhausted after the remaining fluorine removal process. That is, the fluorine compound adsorbed on the inner surface of the chamber 10 was removed by the remaining fluorine removal process.

### Example 2

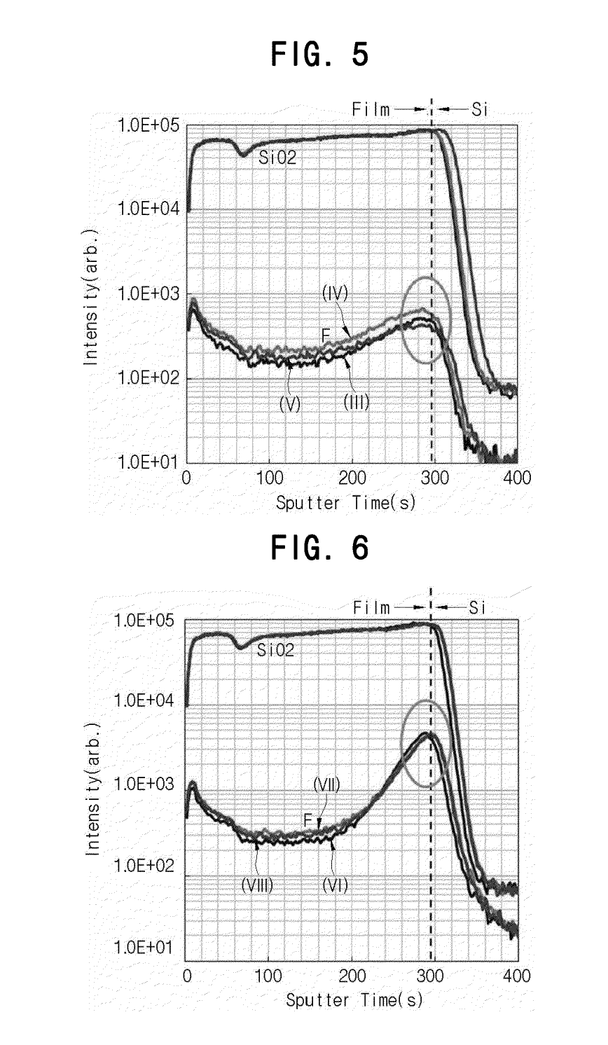

FIG. 5 is a graph illustrating an amount of a fluorine atom in a silicon oxide layer deposited on a silicon substrate, while performing a method of cleaning a semiconductor device manufacturing apparatus in accordance with the Comparative Example, and FIG. 6 is a graph illustrating an amount of a fluorine atom in a silicon oxide layer deposited on a silicon substrate, while performing a method of cleaning a semiconductor device manufacturing apparatus in accordance with Example 2.

In the method of cleaning the semiconductor device manufacturing apparatus in accordance with the Comparative Example, the silicon oxide layer was formed on the silicon substrate, the cleaning process was performed using nitrogen trifluoride (NF₃), and the exhaust process was performed. In the method of cleaning the semiconductor device manufacturing apparatus in accordance with Example 2, after performing the cleaning process and the exhaust process, the remaining fluorine removal process was further performed. The amount of the fluorine atom in the silicon oxide layer was observed by a secondary ion mass spectroscopy (SIMS).

Referring to FIG. 5, silicon oxide layers (IV) and (V) formed after the cleaning process contained more fluorine atoms than a silicon oxide layer (III) formed before the cleaning process. That is, the fluorine atoms formed during the cleaning process using NF3 remained in the chamber 10, and then the remaining fluorine atoms were included in the silicon oxide layers that were formed after the cleaning process.

Referring to FIG. 6, silicon oxide layers (VI) and (VII) formed after the remaining fluorine removal process contained substantially the same amount of fluorine atoms as a silicon oxide layer (VIII) formed before the cleaning process and the remaining fluorine removal process. That is, the fluorine atoms formed during the cleaning process using NF₃ were removed by the remaining fluorine removal process, so that the remaining fluorine were not included in the silicon oxide layers that were formed after the cleaning process and the remaining fluorine removal process.

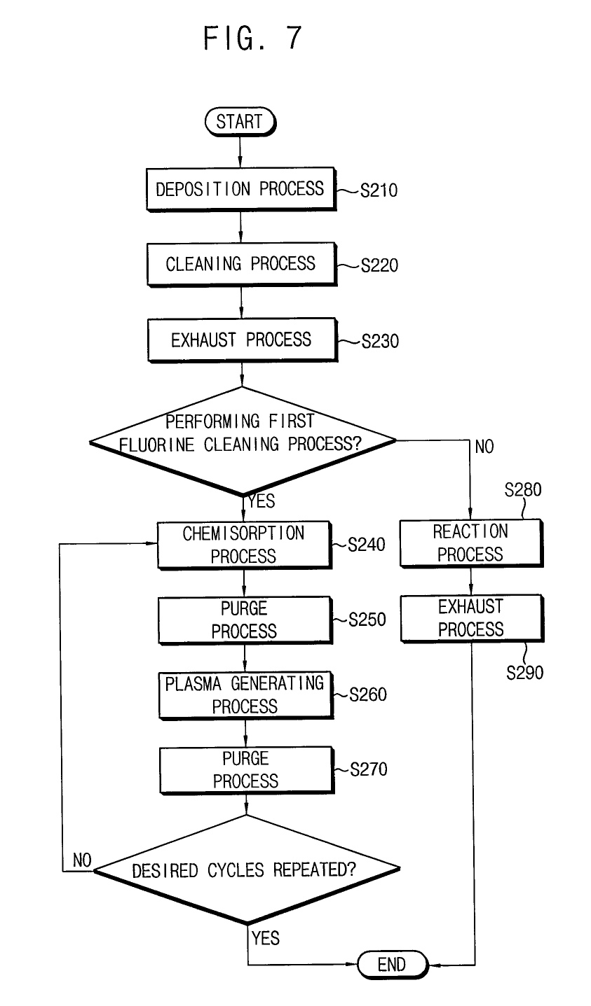

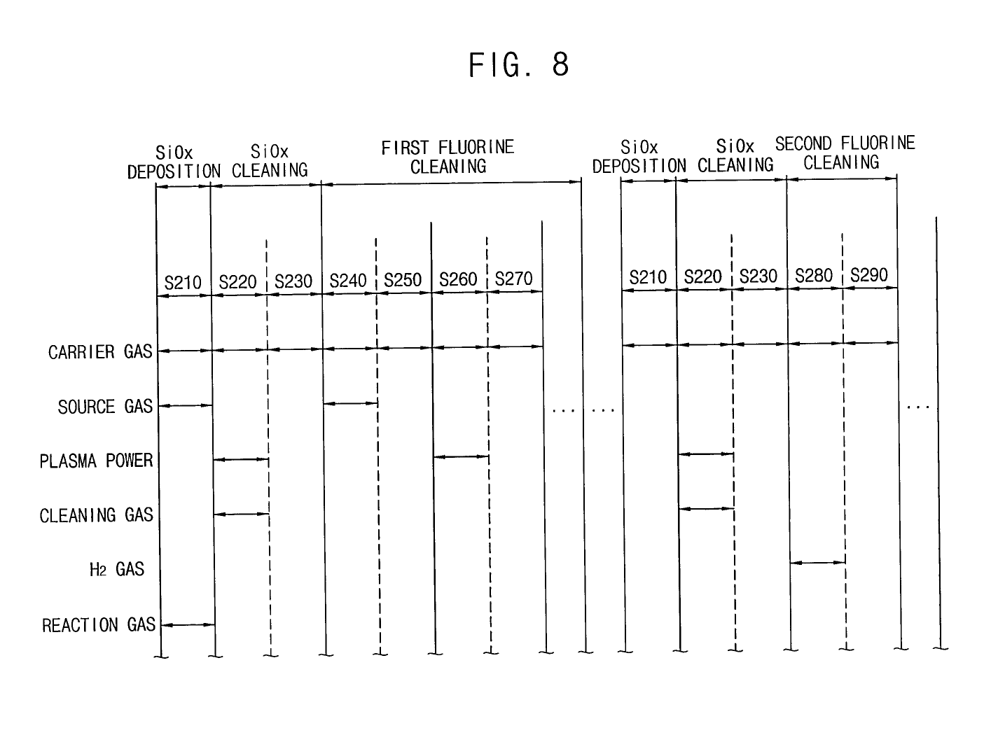

FIG. 7 is a flow chart illustrating a method of cleaning a semiconductor device manufacturing apparatus in accordance with example embodiments, and FIG. 8 is a timing diagram illustrating a method of cleaning a semiconductor device manufacturing apparatus in accordance with example embodiments.

The semiconductor device manufacturing apparatus illustrated with reference to FIG. 7 may be a semiconductor device manufacturing apparatus described with reference to FIG. 1. That is, the semiconductor device manufacturing apparatus may include the chamber 10 for performing an ALD process or a CVD process.

The method of cleaning the semiconductor device manufacturing apparatus may be substantially the same as or similar to those described with reference to FIGS. 2 and 3, and thus detailed explanations thereon are omitted here.

Referring to FIGS. 7 and 8, in step S210, i.e., in a deposition process, a layer structure may be formed on the substrate 40 in the chamber 10. In step S210, processes substantially the same as or similar to those in the step S110 described with reference to FIGS. 2 and 3 may be performed.

That is, the source gas, the carrier gas, and the reaction gas may be provided into the chamber 10 to form the layer structure on the substrate 40. In example embodiments, the source gas may include di-isopropylaminosilane (DIPAS), tetra ethyl ortho silicate (TEOS), trimethyl phosphate (TMOP), triethyl borate (TEB), etc., the carrier gas may include Ar, N₂, He, etc., and the reaction gas may include O₂, H₂O, H₂O₂, etc. In this case, a byproduct (not shown) containing silicon oxide (SiOx) may be formed on the inner surface of the chamber 10 as well as on the substrate 40.

In step S220, processes substantially the same as or similar to those in step S120 described with reference to FIGS. 2 and 3 may be performed. That is, the byproduct including silicon oxide (SiOx) on the inner surface of the chamber 10 may be removed using the cleaning gas and the carrier gas provided into the chamber 10.

In example embodiments, the cleaning gas may include C₂F₆ and/or NF₃, and the carrier gas may include Ar, N₂, He, etc. In an example embodiment, a temperature in the chamber 10 during the cleaning process may be substantially the same as a temperature during the deposition process, so that a process time for performing the cleaning process may be reduced. Plasma may be formed in the chamber 10. Fluorine radical (F*) in the plasma and silicon oxide (SiOx) in the byproduct may be reacted to form a silicon tetrafluoride (SiF₄) gas and an oxygen (O₂) gas which may be volatile. The cleaning process may be performed for a period of time in a range of about 3 minutes to about 10 minutes.

In step S230, i.e., in an exhaust process, processes substantially the same as or similar to those in step S130 described with reference to FIGS. 2 and 3 may be performed. That is, the carrier gas may be provided into the chamber 10, and then the volatile SiF₄ gas and O₂ gas may be exhausted out of the chamber 10. The exhaust process may be performed for more than about 1 minute. Even through a process time of the exhausted process may extend, remaining fluorine atoms or remaining fluorine radicals may not be entirely removed in the chamber 10.

In an example embodiment, a first remaining fluorine removal process and a second remaining fluorine removal process may be selectively performed. In another example embodiment, after step S230, the first remaining fluorine removal process and the second remaining fluorine removal process may be performed alternatively, and in this case the second remaining fluorine removal process may be performed firstly. The first remaining fluorine removal process and the second remaining fluorine removal process may be described hereinafter.

The first remaining fluorine removal process may include a step S240 (a chemisorption process), step S250 (a first purge process), step S260 (plasma generating process), and step S270 (a second purge process).

In the step S240, processes substantially the same as or similar to those in step S140 described with reference to FIGS. 2 and 3 may be performed. That is, an organic compound source gas and the carrier gas may be provided into the chamber 10, and an organic compound source material may be chemisorbed on the inner surface of the chamber 10. The organic compound source gas may be substantially similar to or the same as the source gas used during the deposition process. In an example embodiment, the chemisorption process may be performed for a period of time in a range of about 0.5 seconds to about 2 seconds, however, the process time of the chemisorption process may vary in accordance with the size of the chamber 10 and/or the lengths and layouts of the gas supply lines 70, 72 and 74 as understood by one skilled in the art.

In step S250, processes substantially the same as or similar to those in step S150 described with reference to FIGS. 2 and 3 may be performed. That is, the carrier gas may be provided into the chamber 10, so that the remaining organic compound source gas in the chamber 10 may be exhausted to purge the chamber 10. In an example embodiment, the first purge process may be performed for a period of time in a range of about 0.5 seconds to about 2 seconds, however, the process time may vary in accordance with the size of the chamber 10 and the capacity of the pump 60 as understood by one skilled in the art.

In step S260, processes substantially the same as or similar to those in step S160 described with reference to FIGS. 2 and 3 may be performed. That is, a plasma may be generated in the chamber 10 as the carrier gas may be provided into the chamber 10. In example embodiments, a power from the high frequency power supply 50 may be applied into the chamber 10 to generate a direct plasma in the chamber 10, and the high frequency power supply 50 may apply a power in a range of about 200 W to about 400 W. The direct plasma may facilitate a reaction between the source material chemisorbed on the inner surface of the chamber 10 and the remaining fluorine atoms or the remaining fluorine radicals, so that silicon fluoride (SiFx) and hydrogen fluoride (HF) may be formed in the chamber 10. The plasma generating process may be performed for a period of time in a range of about 0.5 seconds to about 3 seconds, however, the process time of the plasma generating process may vary in accordance with the size of the chamber 10 and the capacity of the high frequency power supply 50 as understood by one skilled in the art.

In step S270, processes substantially the same as or similar to those in the step S170 described with reference to FIGS. 2 and 3 may be performed. That is, the remaining SiFx gas and HF gas formed in step S260 may be exhausted to purge the chamber 10. The second purge process may be performed for a period of time in a range of about 0.5 seconds to about 3 seconds, however, the process time of the second purge process may vary in accordance with the size of the chamber 10 and the capacity of the pump 60 as understood by one skilled in the art.

The first remaining fluorine removal process, which may include the above-described processes, that is, the chemisorption process (step S240), the first purge process (step S150), the plasma generating process (step S260) and the second purge process (step S270) may be repeated, so that the remaining gas containing fluorine in the chamber 10 may be removed sufficiently.

The second remaining fluorine removal process may include step S280 (a reaction process) and step S290 (an exhaust process).

In step S280, a cleaning gas and a carrier gas may be provided into the chamber 10 through the cleaning gas supply line 74, so that remaining fluorine atoms or radicals may be removed in the chamber 10.

In example embodiments, the cleaning gas may include a H₂ gas or a gas containing hydrogen (H) atom, and the carrier gas may include Ar, Ne, N₂, etc. A pressure and a gas ratio in the chamber 10 may be adjusted by providing the carrier gas as understood by one skilled in the art.

In an example embodiment, a temperature in the chamber 10 at the reaction process (step S270) may be substantially the same as a temperature during the deposition process (step S210). A time for changing the temperature in the chamber 10 may not be necessary, so that a process time for the reaction process (step S270) may be reduced.

Plasma may be generated in the chamber 10. In example embodiments, the plasma may be generated by a remote plasma process. That is, the cleaning gas may be excited outside the chamber 10. More particularly, the remote power supply 55 may be connected to the cleaning gas supply line 74 to form the plasma, and then the generated plasma may enter the chamber 10.

Hydrogen radical (H*) in the generated plasma and the remaining fluorine in the chamber 10 may be reacted to form a HF gas which may be volatile.

In step S290, processes substantially the same as or similar to those in step S130 described with reference to FIGS. 2 and 3 may be performed. That is, the HF gas formed at step S280 may be exhausted out of the chamber 10. The exhaust process may be performed more than about one minute, however, the process time of the exhaust process may vary in accordance with the size of the chamber 10 and the capacity of the pump 60 as understood by one skilled in the art.

The first and second remaining fluorine removal processes may be performed under a pressure in a range of about 1 Torr to about 3 Torr at a temperature in a range of about a room temperature to about 500° C. In an example embodiment, a temperature in the chamber 10 at the first and second remaining fluorine removal processes may be substantially the same as a temperature during the processes which may include the chemisorption process (step S110), the cleaning process (step S120) and/or the exhaust process (step S130). Therefore, a time for changing the temperature in the chamber 10 may not be necessary, and thus, a process time may be reduced.

As mentioned above, in the method of cleaning the semiconductor device manufacturing apparatus, the remaining fluorine compound in the chamber 10 may be removed by performing the first remaining fluorine removal process and the second remaining fluorine removal process, selectively. Further, the cleaning process and the first and second remaining fluorine removal processes may be performed in-situ at a temperature substantially the same as the temperature of the deposition process, so that the method may clean the semiconductor device manufacturing apparatus more efficiently.

According to example embodiments, the silicon oxide deposited on the inner surface of the chamber 10 may be firstly removed using a gas containing fluorine, a material substantially similar to or the same as the source gas used at the deposition process of the silicon oxide may be chemisorbed on the inner surface of the chamber 10, and a plasma may be generated. The plasma may facilitate the reaction between the material chemisorbed on the inner surface of the chamber 10 and the fluorine compounds.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A method of cleaning a semiconductor device manufacturing apparatus comprising:
providing a fluorine-containing gas into a chamber to clean a byproduct formed on an inner surface of the chamber during formation of a layer structure therein;
providing a material into the chamber to chemisorb the material on the inner surface of the chamber, the material substantially similar to or the same as a source gas used to form the layer structure;
generating a plasma in the chamber; and
purging the chamber to remove substantially the fluorine-containing gas.

2. The method of claim 1, wherein the layer structure and the byproduct include silicon oxide.

3. The method of claim 2, wherein the source gas includes at least one of di-isopropylaminosilane (DIPAS), tetra ethyl ortho silicate (TEOS), trimethyl phosphate (TMOP), and triethyl borate (TEB).

4. The method of claim 3, wherein generating the plasma includes forming silicon fluoride (SiFx) and hydrogen fluoride (HF).

5. The method of claim 1, wherein generating the plasma includes performing a direct plasma process.

6. The method of claim 1, wherein providing the material and generating the plasma are performed at a temperature substantially the same as a temperature employed during a process for forming the layer structure.

7. The method of claim 6, wherein providing the fluorine-containing gas, providing the material, generating the plasma and purging the chamber are performed at a temperature substantially the same as the temperature of the process for forming the layer structure.

8. The method of claim 1, prior to generating the plasma, further comprising:
providing a carrier gas into the chamber to purge the chamber.

9. The method of claim 1, after providing the fluorine-containing gas, further comprising:
providing a carrier gas into the chamber to exhaust from the chamber a remaining gas that contains fluorine.

10. The method of claim 1, wherein providing the material, generating the plasma and purging the chamber are performed repeatedly.

11. The method of claim 1, wherein the layer structure is formed by an atomic layer deposition (ALD) process or a chemical vapor deposition (CVD) process.

12. The method of claim 1, after providing the material, further comprising:
providing a hydrogen-containing gas into the chamber;
generating the plasma in the chamber; and
purging the chamber.

13. The method of claim 12, prior to providing the material, further comprising:
providing a hydrogen-containing gas into the chamber;
generating the plasma in the chamber; and
purging the chamber.

14. The method of claim 1, after purging the chamber, further comprising
providing a hydrogen-containing gas into the chamber;
generating the plasma in the chamber; and
purging the chamber.

15. A method of removing a silicon oxide layer from a surface, the method comprising:
subjecting the surface having the silicon oxide layer thereon to a gas comprising fluorine;
providing a material to the surface for chemisorption of said material to the surface;
generating a plasma to facilitate a reaction between the material and fluorine atoms or fluorine radicals remaining after chemisorption; and
providing a carrier gas to purge substantially the gas comprising fluorine from the surface.

16. The method of claim 15, wherein the surface is an inner surface of a semiconductor device manufacturing apparatus.

17. The method of claim 15, wherein the gas comprising fluorine is hexafluoroethane (C₂F₆) or nitrogen trifluoride (NF₃).

18. The method of claim 15, wherein the material includes at least one of di-isopropylaminosilane (DIPAS), tetra ethyl ortho silicate (TEOS), trimethyl phosphate (TMOP) and triethyl borate (TEB).

19. The method of claim 15, wherein the carrier gas is an inert gas.

20. The method of claim 15, wherein providing the material to the surface, generating the plasma and providing the carrier gas are performed repeatedly.
